(19) United States
(12) Patent Application Publication
(10) Pub. No.: US 2012/0298150 A1
(43) Pub. Date: Nov. 29, 2012

(54) CLEANING AND DRYING APPARATUS

(75) Inventors: YING-SHU CHEN, Shindian (TW); JIAN-PING JIN, Shenzhen City (CN); XIAO-GANG ZHANG, Shenzhen City (CN); BING YU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/284,697

(22) Filed: Oct. 28, 2011

(30) Foreign Application Priority Data
May 23, 2011 (CN) 201110132303.5

(51) Int. Cl. B08B 3/00

(52) U.S. Cl. 134/94.1

(57) ABSTRACT

A cleaning and drying apparatus includes a support frame, a washing and drying cabinet, a blower module, and a water tank. The support frame includes a first frame, a second frame, a number of pillars connected to the first frame and the second frame. The washing and drying cabinet is mounted on the second frame. The blower module is mounted on the first frame, the water tank is mounted on the first frame, and the blower module and the water tank are connected to the washing and drying cabinet.

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US39180 | AIR KNIFE MODULE | Chen et al. |
| US39181 | NOZZLE ASSEMBLY FOR SPRAY | Chen et al. |
| | APPARATUS | |
| US39182 | AIR DRYING APPARATUS | Chen et al. |
| US39183 | CLEANING AND DRYING APPARATUS | Chen et al. |

### BACKGROUND

1. Technical Field

The present disclosure generally relates to cleaning and drying apparatus, and particularly to a cleaning and drying apparatus which may be quickly assembled.

2. Description of Related Art

Cleaning and drying apparatus are used for cleaning and drying objects. After a period of time, dust/debris may accumulate in the apparatus. In order to remove the debris/dust from the apparatus, the apparatus needs to be disassembled. Since the assembly process of the conventional cleaning and drying apparatus can be very complicated, the disassembly process can be very complicated and time-consuming.

Therefore, there is room for improvement within the art.

### BRIEF DESCRIPTION OF THE DRAWINGS

Many aspects of the cleaning and drying apparatus can be better understood with reference to the following drawings. The components in the drawings are not necessarily to scale, the emphasis instead being placed upon clearly illustrating the cleaning and drying apparatus. Moreover, in the drawings, like reference numerals designate corresponding parts throughout the several views.

FIG. 1 is a schematic view of a cleaning and drying apparatus according to an exemplary embodiment.

FIG. 2 is similar to FIG. 1, but shown from another aspect.

FIG. 3 is an exploded view of the cleaning and drying apparatus of FIG. 1

### DETAILED DESCRIPTION

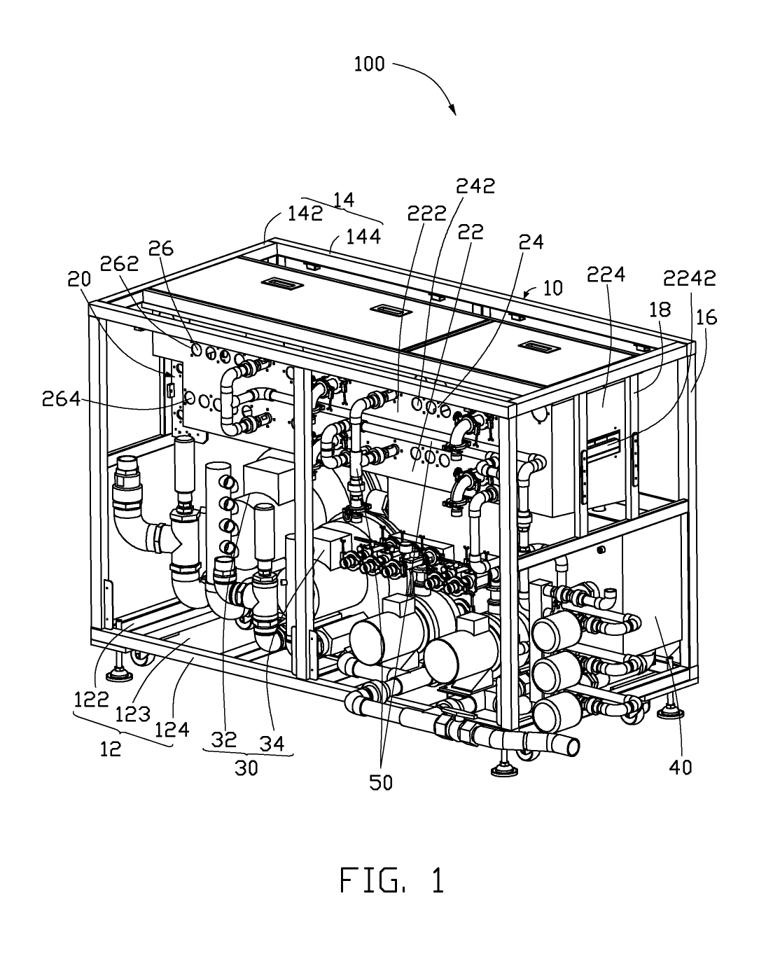

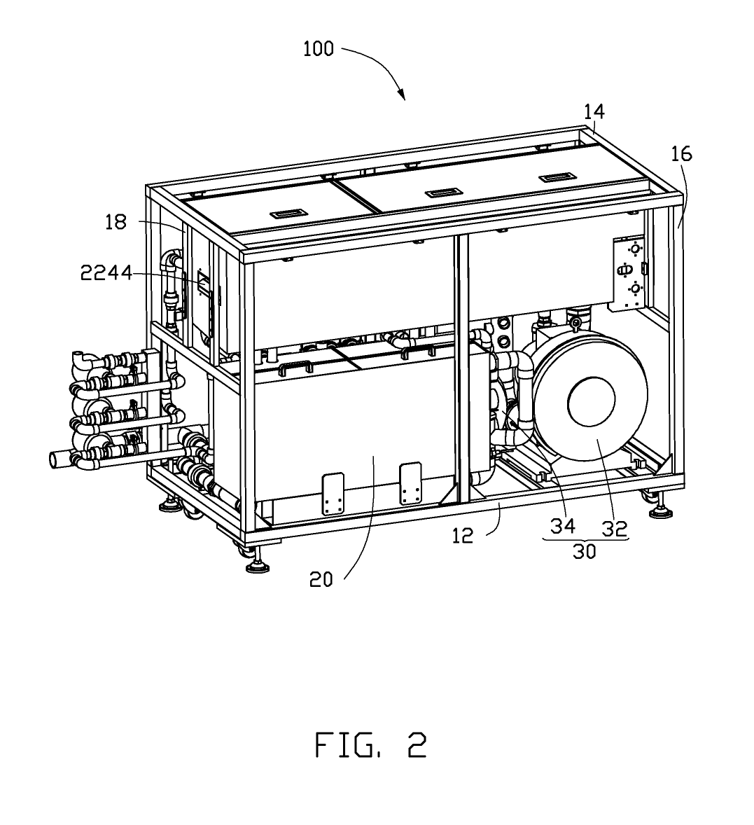

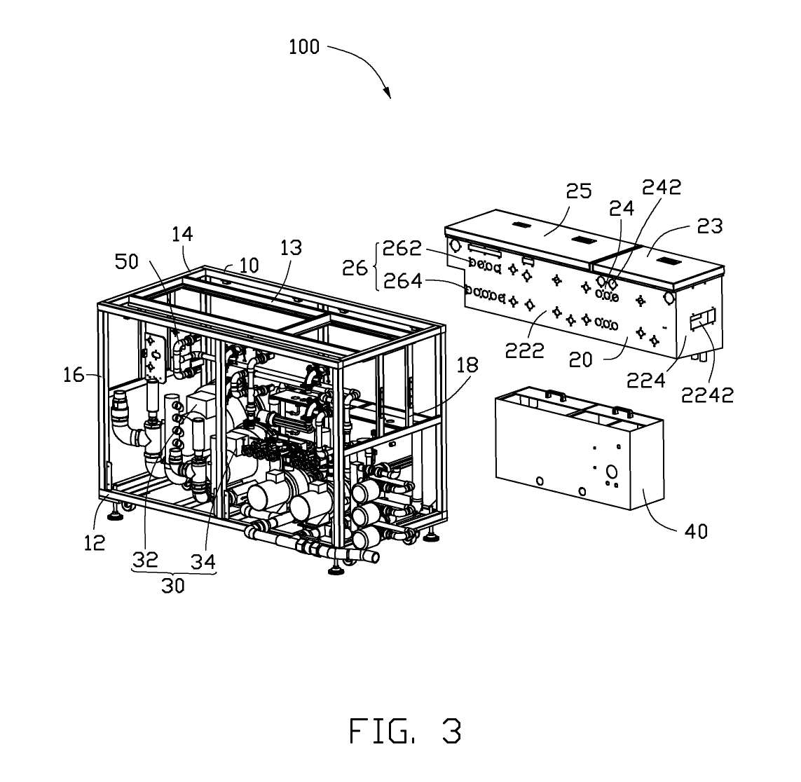

FIGS. 1 to 3 show an exemplary embodiment of a cleaning and drying apparatus 100. The apparatus 100 includes a washing and drying cabinet 20, a blower module 30, and a water tank 40 mounted in a support frame 10. The blower module 30 and the water tank 40 are connected to the cabinet 20 by a number of pipes 50.

The support frame 10 includes a first frame 12, a second frame 14, a number of pillars 16 connected to the first frame 12 and the second frame 14, and a pair of middle frames 18. The first frame 12 includes opposite first rods 122 and opposite second rods 124. The first rods 122 are shorter than the second rods 124. The structure of the second frame 14 is similar to the support frame 10, and also includes opposite first rods 142 and opposite second rods 144. In this exemplary embodiment, there are six pillars 16. Four of the six pillars 16 are connected to four corners of the first frame 12 and the second frame 14, the remaining six pillars 16 are connected to the second rods 124, 144 of the first frame 12 and the second frame 14. In order to strengthen the first frame 12, a number of reinforcing rods 123 are placed to ride between the second rods 124, and are parallel to the first rods 124. In order to strengthen the second frame 14, a holding frame 13 is embedded in the second frame 14 for holding the cabinet 20. Each middle frame 18 is mounted to one side of the second frame 14 for mounting the cabinet 20.

The cabinet 20 includes a work chamber 22, a spray module 24, and an air knife module 26. The work chamber 22 includes opposite sidewalls 222 and opposite end walls 224. One of the end walls 224 defines an entrance 2242, and the other end wall 224 defines an exit 2244. Objects may be transported on conveyor belts to enter through the entrance 2242, and exit from the exit 2244. The work chamber 22 includes a washing chamber 23 and a drying chamber 25. The spray module 24 is mounted in the washing chamber 23, and includes at least two groups of spray heads 242. The at least two groups of the spay heads 242 are mounted on opposite sidewalls 222 for spraying the objects from directions. The air knife module 26 is mounted in the drying chamber 25, and includes two groups of first air knives 262 mounted on opposite sidewalls 222 respectively, and two groups of second air knives 264 also mounted on the opposite sidewalls 222 respectively. Each group of second air knives 264 is below a corresponding group of first air knives 262.

The blower module 30 is mounted on the first frame 12, and includes a first air blower 32 and a second air blower 34. The power of the first air blower 32 is greater than the power of the second air blower 34. The first air blower 30 is connected to the first air knives 262 for supplying the air. The second air blower 40 is connected to the second air knives 264 for supplying the air.

When the apparatus 100 is assembled, the blower module 30 is mounted to the first frame 12 of the support frame 10 with fasteners such as screws. The water tank 40 is assembled to the first frame 12 adjacent to the blower module 30. The cabinet 20 is placed in the support frame 10 through the second frame 14, and is supported on the holding frame 13. The cabinet 20 is mounted on the middle frame 18 with fasteners such as screws. Finally, the pipes 50 connect the spray module 24 to the water tank 40, and connect the air knives module 26 to the blower module 30. Since the components of the apparatus 100 are divided into several modules, and the support frame 10 is configured for receiving the modules, it is convenient to quickly assemble and disassemble the apparatus 100 for cleaning and maintenance.

In use, the spraying heads 242 are turned on, and the objects to be washed are conveyed between the spraying heads 242. After the objects are washed, the objects are conveyed between the first air knives 24 and the second air knives 26. The first air blower 32 and the second air blower 34 are turned on. The first blower 32 supplies air to the air knives 262 through the pipes 50. The second blower 34 supplies air to the second air knives 264 through the pipes 50. Because the power of the first air blower 32 is greater than the power of the second air blower 34, the objects remain steadfast on the conveyors (not shown).

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cleaning and drying apparatus comprising:
a support frame including a first frame, a second frame, a number of pillars connected to the first frame and the second frame;
a washing and drying cabinet mounted on the second frame;
a blower module mounted on the first frame, a water tank mounted on the first frame, the blower module and the water tank connected to the washing and drying cabinet.

2. The cleaning and drying apparatus as claimed in claim 1, wherein the first frame includes opposite first rods and opposite second rods connected to each other, the first rods are shorter than the second rods.

3. The cleaning and drying apparatus as claimed in claim 2, wherein the second frame includes opposite first rods and opposite second rods connected to each other.

4. The cleaning and drying apparatus as claimed in claim 3, wherein there are six pillars, four of the six pillars are connected to four corners of the first frame and the second frame, the other of the six pillars are connected to the second rods of the first frame and the second frame.

5. The cleaning and drying apparatus as claimed in claim 4, wherein a plurality of reinforcing rods ride between the second rods, and are parallel to the first rods.

6. The cleaning and drying apparatus as claimed in claim 5, wherein a holding frame is embedded in the second frame for holding the washing and drying cabinet.

7. The cleaning and drying apparatus as claimed in claim 6, wherein the support frame further includes a middle frame mounted to one side of the second frame for holding the cleaning and drying cabinet.

8. The cleaning and drying apparatus as claimed in claim 1, wherein the washing and drying cabinet includes a work chamber, a spray module and an air knife module, the work chamber includes a washing chamber and a drying chamber, the spray module is mounted in the washing chamber, and the air knife module is mounted in the drying chamber.

9. The cleaning and drying apparatus as claimed in claim 8, wherein the air knife module includes two groups of first air knives and two groups of second air knives, and the second air knives are below the first air knives.

10. The cleaning and drying apparatus as claimed in claim 9, wherein the blower module includes a first air blower and the second air blower, the power of the first air blower is greater than the power of the second air blower, the first air blower is connected to the first air knives, and the second air blower is connected to the second air knives.

11. A cleaning and drying apparatus comprising:
a support frame including a first frame, a second frame and a support frame;
a washing and drying cabinet mounted on the support frame and the second frame;
a blower module mounted on the first frame, a water tank mounted on the first frame, the blower module and the water tank connected to the washing and drying cabinet.

12. The cleaning and drying apparatus as claimed in claim 11, wherein a holding frame is embedded in the second frame for holding the washing and drying cabinet.

13. The cleaning and drying apparatus as claimed in claim 12, wherein the support frame further includes a middle frame mounted to one side of the second frame for holding the cleaning and drying cabinet.

14. The cleaning and drying apparatus as claimed in claim 11, wherein the washing and drying cabinet includes a work chamber, a spray module and an air knife module, the work chamber includes a washing chamber and a drying chamber, the spray module is mounted in the washing chamber, and the air knife module is mounted in the drying chamber.
